(19) United States
(12) Patent Application Publication
(10) Pub. No.: US 2024/0177024 A1
(43) Pub. Date: May 30, 2024

(54) SYSTEM AND METHOD FOR MANAGING INFERENCE MODELS BASED ON INFERENCE GENERATION FREQUENCIES

(71) Applicant: Dell Products L.P., Round Rock, TX (US)

(72) Inventors: OFIR EZRIELEV, Beer Sheva (IL); JEHUDA SHEMER, Kfar Saba (IL); TOMER KUSHNIR, Omer (IL)

(21) Appl. No.: 18/060,104

(22) Filed: Nov. 30, 2022

(51) Int. Cl. G06N 5/04; G06N 5/022

(52) U.S. Cl. CPC G06N 5/04; G06N 5/022

(57) ABSTRACT

Methods and systems for managing execution of an inference model hosted by data processing systems are disclosed. To manage execution of the inference model, a system may include an inference model manager and any number of data processing systems. The inference model manager may identify an inference frequency capability of the inference model hosted by the data processing systems and may determine whether the inference frequency capability of the inference model meets an inference frequency requirement of a downstream consumer during a future period of time. If the inference frequency capability does not meet the inference frequency requirement of the downstream consumer, the inference model manager may modify a deployment of the first inference model to meet the inference frequency requirement of the downstream consumer.

### FIELD

Embodiments disclosed herein relate generally to inference generation. More particularly, embodiments disclosed herein relate to systems and methods to manage inference generation based on inference consumer expectations.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIG. 2A shows a block diagram illustrating an inference model manager and multiple data processing systems over time in accordance with an embodiment.

FIG. 2B shows a block diagram illustrating multiple data processing systems over time in accordance with an embodiment.

FIG. 2C shows a block diagram illustrating an inference model manager over time in accordance with an embodiment.

FIG. 2D shows a block diagram illustrating an inference model manager and multiple data processing systems over time in accordance with an embodiment.

FIG. 3A shows a flow diagram illustrating a method of managing execution of an inference model hosted by data processing systems in accordance with an embodiment.

FIG. 3B shows a flow diagram illustrating a method of obtaining an execution plan in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

In general, embodiments disclosed herein relate to methods and systems for managing execution of an inference model throughout a distributed environment. To manage execution of the inference model, the system may include an inference model manager and any number of data processing systems. Inferences generated by the inference model may be usable by a downstream consumer. The inference frequency capability of the inference model (e.g., the rate of execution of the inference model) may depend on characteristics of the data processing systems to which the inference model is deployed. The downstream consumer may require changes to the inference generation frequency of the inference model over time in response to events, changes to the performance of the downstream consumer, and/or for other reasons. However, a static deployment of the inference model may not allow for modification of the inference generation frequency to meet changing inference frequency requirements of the downstream consumer.

To meet changing inference frequency requirements the downstream consumer, the inference model manager may dynamically modify the inference frequency capability of the inference model. To do so, the inference model manager may obtain an inference frequency capability of the inference model and determine whether the inference frequency capability of the inference model meets an inference frequency requirement of the downstream consumer during a future period of time.

If the inference frequency capability of the inference model does not meet the inference frequency requirement of the downstream consumer during the future period of time, the inference model manager may obtain an execution plan for the inference model. The execution plan for the inference model may include instructions for modifying a deployment of the inference model to meet the inference frequency requirement of the downstream consumer during the future period of time. The execution plan may include, for example, instructions to deploy more instances of the inference model, instructions to replace instances of the inference model with instances of another (less computationally costly) inference model, and/or other instructions.

Thus, embodiments disclosed herein may provide an improved system for inference generation by an inference model deployed across multiple data processing systems to meet an inference frequency requirement of a downstream consumer during a future period of time. The improved system may monitor upcoming events that may impact execution of the inference model and may take proactive action to adjust deployment of the inference model to meet the predicted inference frequency requirement of the downstream consumer. Modifying the deployment of the inference model may optimize the number of inference model instances required to meet the inference frequency requirement of the downstream consumer during the future period of time. Optimizing the number of inference model instances may, at least in some cases, reduce the number of inference model instances deployed throughout the distributed environment. Consequently, a distributed environment in accordance with embodiments disclosed herein may utilize fewer computing resources during inference generation when compared to systems that do not implement the disclosed embodiments.

In an embodiment, a method of managing execution of a first inference model hosted by data processing systems is provided. The method may include: obtaining an inference frequency capability of the first inference model, the inference frequency capability indicating a rate of execution of the first inference model; making a first determination regarding whether the inference frequency capability of the first inference model meets an inference frequency requirement of a downstream consumer during a future period of time; if the inference frequency capability of the first inference model does not meet the inference frequency requirement of the downstream consumer: obtaining an execution plan for the first inference model based on the inference frequency requirement of the downstream consumer; and prior to the future period of time, modifying a deployment of the first inference model to the data processing systems based on the execution plan.

The inference frequency capability of the first inference model may be based on historical data indicating the rate of execution of the first inference model during a previous period of time.

Making the first determination may include: obtaining data anticipating an event impacting execution of the first inference model; and obtaining the inference frequency requirement of the downstream consumer during the future period of time based on the data anticipating the event impacting the execution of the first inference model.

The data anticipating an event impacting the execution of the first inference model may include one selected from a group consisting of: historical data indicating occurrences of events requiring a change in the inference frequency capability of the first inference model; current operational data of the data processing systems; and a transmission from the downstream consumer indicating a change in operation of the downstream consumer.

Obtaining the inference frequency requirement of the downstream consumer during the future period of time may include: feeding the data anticipating the event impacting the execution of the first inference model into a second inference model, the second inference model being trained to predict the inference frequency requirement of the downstream consumer during the future period of time.

The execution plan may indicate a change in the deployment of the first inference model to meet the inference frequency requirement of the downstream consumer during the future period of time.

Obtaining the execution plan may include: obtaining a quantity of instances of the first inference model required to meet the inference frequency requirement of the downstream consumer during the future period of time based on characteristics of the first inference model; making a second determination that the data processing systems have sufficient computing resource capacity to execute the quantity of instances of the first inference model; and based on the second determination: generating the execution plan specifying which of the data processing systems are to host each of the quantity of the instances of the first inference model.

Obtaining the execution plan may include: obtaining a quantity of instances of the first inference model required to meet the inference frequency requirement of the downstream consumer during the future period of time based on characteristics of the first inference model; making a second determination that the data processing systems do not have sufficient computing resource capacity to execute the quantity of instances of the first inference model; and based on the second determination: obtaining a quantity of instances of a third inference model to be deployed to the data processing systems based on the inference frequency requirement of the downstream consumer during the future period of time; and generating the execution plan specifying which of the data processing systems are to host each of the quantity of the instances of the third inference model.

Obtaining the quantity of the instances of the third inference model may include: obtaining the third inference model, the third inference model being a lower complexity inference model than the first inference model and the data processing systems having capacity to host a sufficient quantity of instances of the third inference model to meet the inference frequency requirement of the downstream consumer during the future period of time; and obtaining an inference frequency capability of the third inference model while hosted by the data processing systems.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

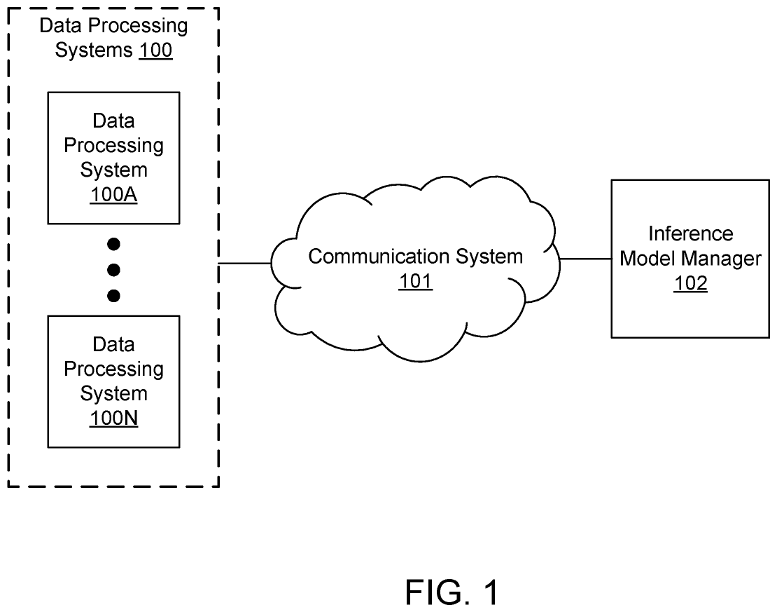

Turning to FIG. 1, a block diagram illustrating a system in accordance with an embodiment is shown. The system shown in FIG. 1 may provide computer-implemented services that may utilize inferences generated by executing an inference model hosted by data processing systems throughout a distributed environment.

The system may include inference model manager 102. Inference model manager 102 may provide all, or a portion, of the computer-implemented services. For example, inference model manager 102 may provide computer-implemented services to users of inference model manager 102 and/or other computing devices operably connected to inference model manager 102. The computer-implemented services may include any type and quantity of services which may utilize, at least in part, inferences generated by the inference model hosted by the data processing systems throughout the distributed environment.

To facilitate execution of the inference model, the system may include one or more data processing systems 100. Data processing systems 100 may include any number of data processing systems (e.g., 100A-100N). For example, data processing systems 100 may include one data processing system (e.g., 100A) or multiple data processing systems (e.g., 100A-100N) that may independently and/or cooperatively facilitate the execution of the inference model.

For example, all, or a portion, of data processing systems 100 may provide computer-implemented services to users and/or other computing devices operably connected to data processing systems 100. The computer-implemented services may include any type and quantity of services including, for example, generation of a partial or complete processing result using the inference model. Different data processing systems may provide similar and/or different computer-implemented services.

The quality of the computer-implemented services may depend on the accuracy of the inferences and, therefore, the complexity of the inference model. An inference model capable of generating accurate inferences may consume an undesirable quantity of computing resources during operation. The addition of a data processing system dedicated to hosting and operating the inference model may increase communication bandwidth consumption, power consumption, and/or computational overhead throughout the distributed environment. Therefore, the inference model may be partitioned into inference model portions and distributed across multiple data processing systems to utilize available computing resources more efficiently throughout the distributed environment.

As part of the computer-implemented services, inferences generated by the inference model may be provided to a downstream consumer. The rate execution of the inference model (e.g., the inference frequency capability of the inference model) may depend on characteristics of the data processing systems to which the inference model is deployed. The inference model may be deployed so that the inference frequency capability of the inference model (when hosted by data processing systems 100) meets an inference frequency requirement of the downstream consumer. However, an event may occur that impacts the inference model's ability to meet the inference frequency requirement of the downstream consumer and/or initiates a change to the inference frequency requirement of the downstream consumer.

A static deployment of the inference model to data processing systems 100 may not allow the inference frequency capability of the inference model to adapt in response to events impacting the inference frequency capability of the inference model and/or the inference frequency requirement of the downstream consumer. If the current deployment of the inference model is not capable of meeting an upcoming inference frequency requirement of the downstream consumer, inference model manager 102 may dynamically modify the deployment of the inference model.

In general, embodiments disclosed herein may provide methods, systems, and/or devices for managing execution of an inference model hosted by data processing systems 100. To manage execution of the inference model hosted by data processing systems 100, a system in accordance with an embodiment may determine whether an inference frequency capability of the inference model meets an inference frequency requirement of the downstream consumer during a future period of time.

If the inference frequency capability of the inference model does not meet the inference generation requirement of the downstream consumer during the future period of time, inference model manager 102 may obtain an execution plan. The execution plan may include instructions for modifying a deployment of the inference model to meet the inference frequency requirement of the downstream consumer.

To meet the inference frequency requirement of the downstream consumer, the execution plan may include instructions for deploying additional redundant instances of the inference model, replacing instances of the inference model with instances of another (less computationally costly) inference model, and/or other instructions. Inference model manager 102 may modify the deployment of the inference model based on the execution plan.

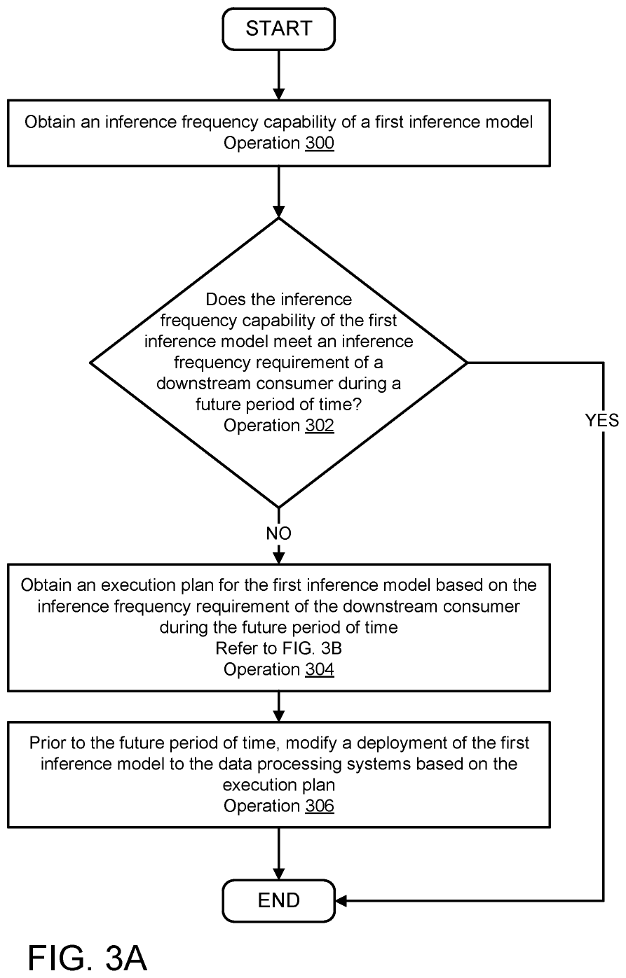

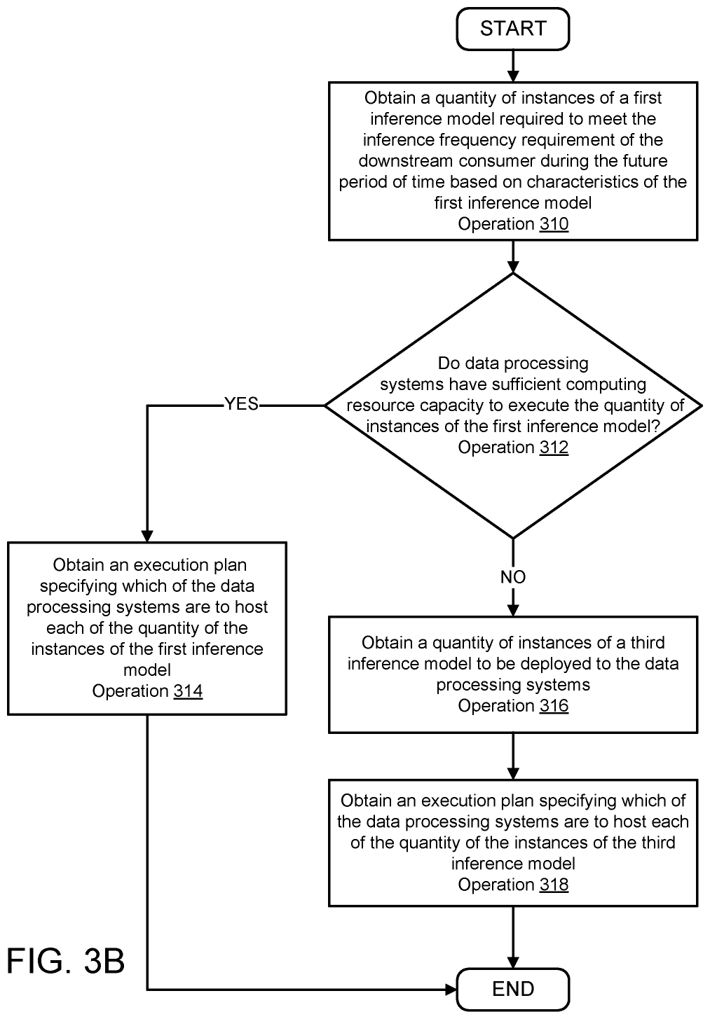

When performing its functionality, inference model manager 102 and/or data processing systems 100 may perform all, or a portion, of the methods and/or actions shown in FIG. 3.

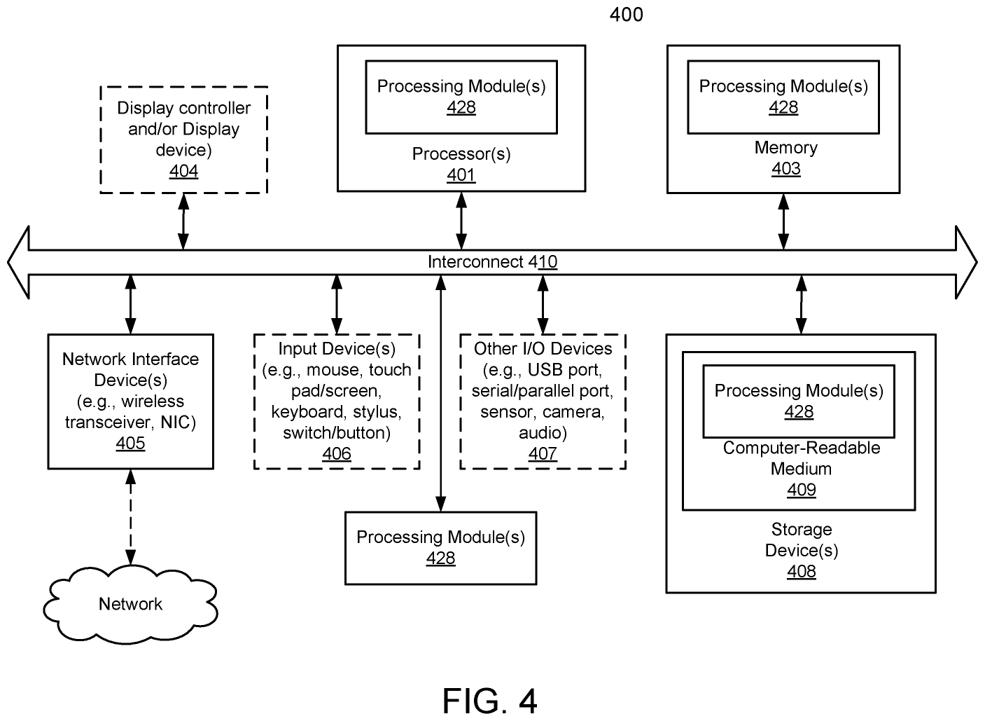

Data processing systems 100 and/or inference model manager 102 may be implemented using a computing device such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

In an embodiment, one or more of data processing systems 100 and/or inference model manager 102 are implemented using an internet of things (IOT) device, which may include a computing device. The IoT device may operate in accordance with a communication model and/or management model known to inference model manager 102, other data processing systems, and/or other devices.

Any of the components illustrated in FIG. 1 may be operably connected to each other (and/or components not illustrated) with communication system 101. In an embodiment, communication system 101 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

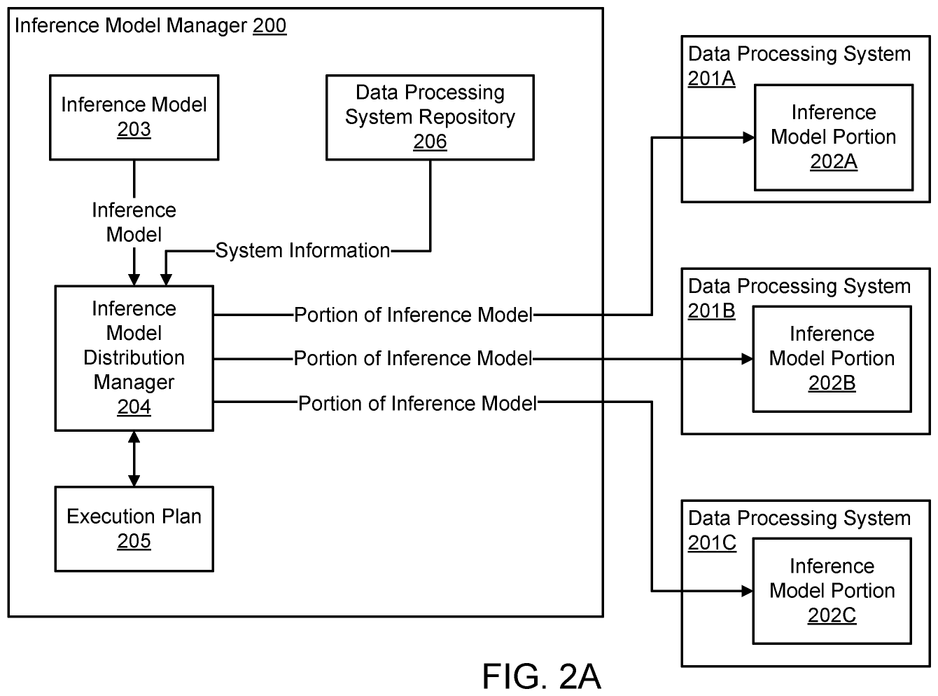

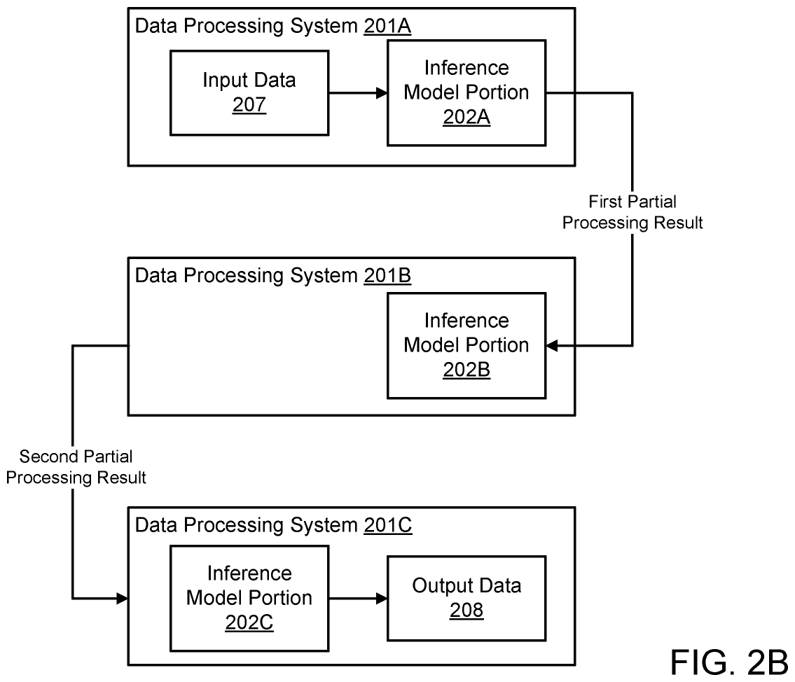

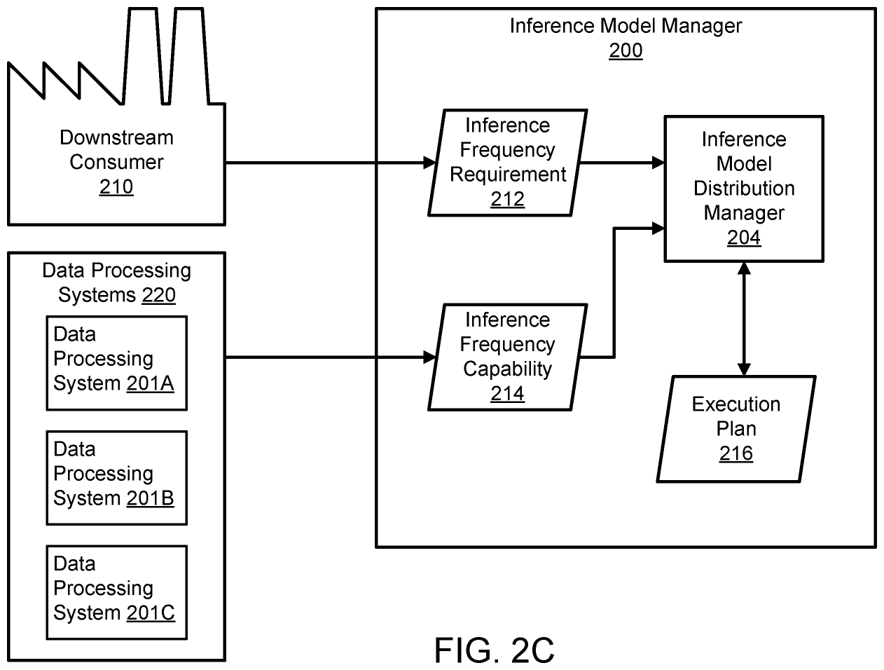

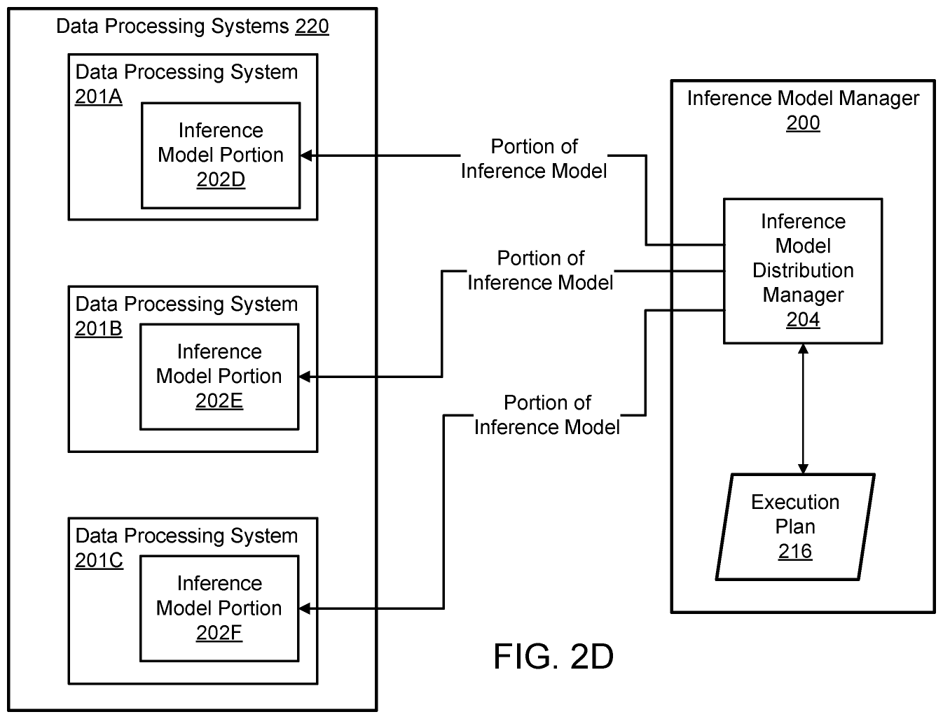

To further clarify embodiments disclosed herein, diagrams illustrating data flows and/or processes performed in a system in accordance with an embodiment are shown in FIGS. 2A-2D.

FIG. 2A shows a diagram of inference model manager 200 and data processing systems 201A-201C in accordance with an embodiment. Inference model manager 200 may be similar to inference model manager 102, and data processing systems 201A-201C may be similar to any of data processing systems 100. In FIG. 2A, inference model manager 200 and data processing systems 201A-201C are connected to each other via a communication system (not shown). Communications between inference model manager 200 and data processing systems 201A-201C are illustrated using lines terminating in arrows.

As discussed above, inference model manager 200 may perform computer-implemented services by executing an inference model across multiple data processing systems that each individually have insufficient computing resources to complete timely execution of the inference model. The computing resources of the individual data processing systems may be insufficient due to: insufficient available storage to host the inference model and/or insufficient processing capability for timely execution of the inference model.

While described below with reference to a single inference model (e.g., inference model 203), the process may be repeated any number of times with any number of inference models without departing from embodiments disclosed herein.

To execute an inference model across multiple data processing systems, inference model manager 200 may obtain inference model portions and may distribute the inference model portions to data processing systems 201A-201C. The inference model portions may be based on: (i) the computing resource availability of data processing systems 201A-201C and (ii) communication bandwidth availability between the data processing systems. By doing so, inference model manager 200 may distribute the computational overhead and bandwidth consumption associated with hosting and operating the inference model across multiple data processing systems while reducing communications between data processing systems 201A-201C throughout the distributed environment.

To obtain inference model portions, inference model manager 200 may host inference model distribution manager 204. Inference model distribution manager 204 may (i) obtain an inference model, (ii) identify characteristics of data processing systems to which the inference model may be deployed, (iii) obtain inference model portions based on the characteristics of the data processing systems and characteristics of the inference model, (iv) obtain an execution plan based on the inference model portions, the characteristics of the data processing systems, and requirements of a downstream consumer (v) distribute the inference model portions to the data processing systems, (vi) initiate execution of the inference model using the inference model portions distributed to the data processing systems and/or (vii) manage the execution of the inference model based on the execution plan.

Inference model manager 200 may obtain inference model 203. Inference model manager 200 may obtain characteristics of inference model 203. The characteristics of inference model 203 may include, for example, a quantity of layers of a neural network inference model and a quantity of relationships between the layers of the neural network inference model. The characteristics of inference model 203 may also include the quantity of computing resources required to host and operate inference model 203. The characteristics of inference model 203 may include other characteristics based on other types of inference models without departing from embodiments disclosed herein.

Each portion of inference model 203 may be distributed to one data processing system throughout a distributed environment. Therefore, prior to determining the portions of inference model 203, inference model distribution manager 204 may obtain system information from data processing system repository 206. System information may include a quantity of the data processing systems, a quantity of available memory of each data processing system of the data processing systems, a quantity of available storage of each data processing system of the data processing systems, a quantity of available communication bandwidth between each data processing system of the data processing systems and other data processing systems of the data processing systems, and/or a quantity of available processing resources of each data processing system of the data processing systems.

Therefore, inference model distribution manager 204 may obtain a first portion of the inference model (e.g., inference model portion 202A) based on the system information (e.g., the available computing resources) associated with data processing system 201A and based on data dependencies of the inference model so that inference model portion 202A reduces the necessary communications between inference model portion 202A and other portions of the inference model. Inference model distribution manager 204 may repeat the previously described process for inference model portion 202B and inference model portion 202C.

Prior to distributing inference model portions 202A-202C, inference model distribution manager 204 may utilize inference model portions 202A-202C to obtain execution plan 205. Execution plan 205 may include instructions for timely execution of the inference model using the portions of the inference model and based on the needs of a downstream consumer of the inferences generated by the inference model.

Inference model manager 200 may distribute inference model portion 202A to data processing system 201A, inference model portion 202B to data processing system 201B, and inference model portion 202C to data processing system 201C. While shown in FIG. 2A as distributing three portions of the inference model to three data processing systems, the inference model may be partitioned into any number of portions and distributed to any number of data processing systems throughout a distributed environment. Further, while not shown in FIG. 2A, redundant copies of the inference model portions may also be distributed to any number of data processing systems in accordance with the execution plan.

Inference model manager 200 may initiate execution of the inference model using the portions of the inference model distributed to the data processing systems to obtain an inference model result (e.g., one or more inferences). The inference model result may be usable by a downstream consumer to perform a task, make a control decision, and/or perform any other action set (or action).

Inference model manager 200 may manage the execution of the inference model based on the execution plan. Managing execution of the inference model may include monitoring changes to a listing of data processing systems over time and/or revising the execution plan as needed to obtain the inference model result in a timely manner and/or in compliance with the needs of a downstream consumer. An updated execution plan may include instructions for re-assignment of data processing systems to new portions of the inference model, re-location of data processing systems to meet the needs of the downstream consumer, determining new inference generation paths to optimize efficiency of inference generation throughout the distributed environment, and/or other instructions. When providing its functionality, inference model manager 200 may use and/or manage agents across any number of data processing systems. These agents may collectively provide all, or a portion, of the functionality of inference model manager 200. As previously mentioned, the process shown in FIG. 2A may be repeated to distribute portions of any number of inference models to any number of data processing systems.

In an embodiment, inference model distribution manager 204 is implemented using a processor adapted to execute computing code stored on a persistent storage that when executed by the processor performs the functionality of inference model distribution manager 204 discussed throughout this application. The processor may be a hardware processor including circuitry such as, for example, a central processing unit, a processing core, or a microcontroller. The processor may be other types of hardware devices for processing information without departing from embodiments disclosed herein.

Turning to FIG. 2B, data processing systems 201A-201C may execute the inference model. To do so, data processing system 201A may obtain input data 207. Input data 207 may include any data of interest to a downstream consumer of the inferences. For example, input data 207 may include data indicating the operability and/or specifications of a product on an assembly line.

Input data 207 may be fed into inference model portion 202A to obtain a first partial processing result. The first partial processing result may include values and/or parameters associated with a portion of the inference model. The first partial processing result may be transmitted (e.g., via a wireless communication system) to data processing system 201B. Data processing system 201B may feed the first partial processing result into inference model portion 202B to obtain a second partial processing result. The second partial processing result may include values and/or parameters associated with a second portion of the inference model. The second partial processing result may be transmitted to data processing system 201C. Data processing system 201C may feed the second partial processing result into inference model portion 202C to obtain output data 208. Output data 208 may include inferences collectively generated by the portions of the inference model distributed across data processing systems 201A-201C.

Output data 208 may be utilized by a downstream consumer of the data to perform a task, make a decision, and/or perform any other action set that may rely on the inferences generated by the inference model. For example, output data 208 may include a quality control determination regarding a product manufactured in an industrial environment. Output data 208 may indicate whether the product meets the quality control standards and should be retained or does not meet the quality control standards and should be discarded. In this example, output data 208 may be used by a robotic arm to decide whether to place the product in a “retain” area or a “discard” area.

While shown in FIG. 2B as including three data processing systems, a system may include any number of data processing systems to collectively execute the inference model. Additionally, as noted above, redundant copies of the inference model hosted by multiple data processing systems may each be maintained so that termination of any portion of the inference model may not impair the continued operation of the inference model. In addition, while described in FIG. 2B as including one inference model, the system may include multiple inference models distributed across multiple data processing systems.

While described above as feeding input data 207 into data processing system 201A and obtaining output data 208 via data processing system 201C, other data processing systems may utilize input data and/or obtain output data without departing from embodiments disclosed herein. For example, data processing system 201B and/or data processing system 201C may obtain input data (not shown). In another example, data processing system 201A and/or data processing system 201B may generate output data (not shown). A downstream consumer may be configured to utilize output data obtained from data processing system 201A and/or data processing system 201B to perform a task, make a decision, and/or perform an action set.

By executing an inference model across multiple data processing systems, computing resource expenditure throughout the distributed environment may be reduced. In addition, by managing execution of the inference model, the functionality and/or connectivity of the data processing systems may be adapted over time to remain in compliance with the needs of a downstream consumer.

Turning to FIG. 2C, consider a scenario in which downstream consumer 210 transmits inference frequency requirement 212 to inference model manager 200. Inference frequency requirement 212 may be based on data anticipating an event impacting execution of the inference model (referred to throughout FIGS. 2C-2D as the first inference model).

In an embodiment, the data anticipating the event impacting execution of the first inference model is historical data indicating occurrences of events requiring a change in the inference frequency capability of the first inference model. For example, the historical data may include a record of changes to the operation of the inference model occurring during different seasons of each year.

In an embodiment, the data anticipating the event impacting execution of the first inference model is current operational data of the data processing systems. The current operational data of the data processing systems may include data related to the ambient environment surrounding the data processing systems and/or other data.

In an embodiment, the data anticipating the event impacting execution of the first inference model is a transmission from the downstream consumer indicating a change in operation of the downstream consumer. The change in operation of the downstream consumer may include, for example, an increase in scale of industrial operations of the downstream consumer and/or a decrease in scale of industrial operations of the downstream consumer.

The inference frequency requirement 212 may be obtained by feeding the data anticipating the event impacting execution of the first inference model into a second inference model (not shown). The second inference model may be trained to predict an inference frequency requirement of the downstream consumer for a future period of time using the data anticipating the event impacting execution of the first inference model as an ingest.

Inference model manager 200 may determine whether data processing systems 220 (including data processing systems 201A-201C and/or additional data processing systems not shown in FIG. 2C) meets inference frequency requirement 212. To do so, inference model manager 200 may obtain inference frequency capability 214 from data processing systems 220. Inference frequency capability 214 may indicate a rate of execution of the first inference model by data processing systems 220. Inference frequency capability 214 may be based on historical data indicating the rate of execution of the first inference model during a previous period of time.

Inference model manager 200 may compare inference frequency requirement 212 to inference frequency capability 214 to determine whether inference frequency capability 214 meets inference frequency requirement 212. If inference frequency capability 214 does not meet inference frequency requirement 212 (due to, for example, a lack of available computing resources and/or a slow down in inference generation due to communication system bandwidth limitations), inference model manager 200 may obtain execution plan 216 for the first inference model.

Execution plan 216 indicate a change in the deployment of the first inference model to meet the inference frequency requirement (e.g., inference frequency requirement 212) of the downstream consumer (e.g., downstream consumer 210) during the future period of time. To do so, inference model manager 200 may obtain a quantity of instances of the first inference model required to meet inference frequency requirement 212 based on characteristics of the first inference model. The characteristics of the first inference model may include, for example, a quantity of layers of a neural network inference model and a quantity of relationships between the layers of the neural network inference model. The characteristics of the first inference model may also include the quantity of computing resources required to host and operate the first inference model. The characteristics of the inference model may include other characteristics based on other types of inference models without departing from embodiments disclosed herein.

Inference model manager 200 may determine whether data processing systems 220 have sufficient computing resource capacity to execute the quantity of instances of the first inference model. If data processing systems 220 have sufficient computing resource capacity to execute the quantity of instances of the first inference model, inference model manager 200 may generate execution plan 216 specifying which of data processing systems 220 are to host each of the quantity of the instances of the first inference model. For example, one instance of the inference model is currently deployed across data processing systems 201A-201C. Execution plan 216 may specify that data processing systems 220 may meet inference frequency requirement 212 by executing two redundant instances of the first inference model. Data processing systems 220 may have sufficient computing resource capacity (via unused computing resource capacity of data processing systems 201A-201C and/or via additional data processing systems of data processing systems 220 not currently hosting any portion of any instance of the first inference model). Therefore, execution plan 216 may include instructions for partitioning and deploying a second instance of the first inference model to data processing systems 220 (not shown).

Turning to FIG. 2D, if data processing systems 220 do not have sufficient computing resource capacity to execute the quantity of instances of the first inference model, inference model manager 200 may obtain a quantity of instances of a third inference model to be deployed to data processing systems 220 based on inference frequency requirement 212. The third inference model may be a lower complexity inference model than the first inference model and, therefore, may consume fewer computing resources during operation than the first inference model. Inference model manager 200 may generate execution plan 216 specifying which of the data processing systems are to host each of the quantity of instances of the third inference model. Data processing systems 220 may have capacity to host a sufficient quantity of instances of the third inference model to meet inference frequency requirement 212.

For example, inference model distribution manager 204 may obtain the third inference model (not shown) and may partition the third inference model into portions (e.g., inference model portions 202D-202F). Inference model distribution manager 204 may distribute inference model portion 202D to data processing system 201A, inference model portion 202E to data processing system 201B, and inference model portion 202F to data processing system 201C in accordance with execution plan 216. By doing so, data processing systems 220 may be able to meet inference frequency requirement 212 of downstream consumer 210. Execution plan 216 may instruct data processing systems 201A-201C to delete, archive, and/or otherwise remove inference model portions 202A-202C. Execution plan 216 may be updated over time to adjust to future changes in the inference generation needs of downstream consumer 210.

As discussed above, the components of FIG. 1 may perform various methods to execute an inference model throughout a distributed environment. FIGS. 3A-3B illustrates methods that may be performed by the components of FIG. 1. In the diagrams discussed below and shown in FIGS. 3A-3B, any of the operations may be repeated, performed in different orders, and/or performed in parallel with or in a partially overlapping in time manner with other operations.

Turning to FIG. 3A, a flow diagram illustrating a method of managing execution of an inference model hosted by data processing systems is shown. The operations in FIG. 3A may be performed by inference model manager 102 and/or data processing systems 100. Other entities may perform the operations shown in FIG. 3A without departing from embodiments disclosed herein.

At operation 300, an inference frequency capability of a first inference model is obtained. The inference frequency capability of the first inference model may be obtained by obtaining historical data indicating a rate of execution of the first inference model during a previous period of time. The historical data may be analyzed to obtain, for example, an average rate of execution of the first inference model during the previous period of time. The average rate of execution of the first inference model during the previous period of time may be dependent on characteristics of the data processing systems to which the first inference model is deployed and, therefore, may be specific to the current deployment of the first inference model. The previous period of time may be selected from a larger quantity of historical data based on: (i) recency of the previous period of time, (ii) similarities (e.g., environmental conditions, etc.) between the previous period of time and a current or future period of time, and/or (iii) based on any other criteria. The obtained average rate of execution of the first inference model may be treated as the inference frequency capability of the first inference model. The inference frequency capability of the first inference model may also be obtained via an analysis of the topology of the first inference model (e.g., neurons of a neural network) and predicting, based on the topology and characteristics of the data processing systems to which the first inference model is deployed, the rate of execution of the first inference model. Inference frequency capabilities may be obtained for any number of inference models and may be obtained via other methods without departing from embodiments disclosed herein.

Rates of inference generation throughout a distributed system may be modified given a limited quantity of available computing resources by, for example, altering the degree of parallelism (e.g., the number of instances of an existing inference model hosted by the data processing systems) and/or by replacing instances of the existing inference model with instances of another inference model with a different topology. For example, the rate of inference generation throughout the system may be increased by replacing an instance of a higher complexity topology inference model with two (or more) instances of a lower complexity topology inference model. The higher complexity topology inference model and the lower complexity topology inference model may have the same rate of execution. However, the lower complexity topology inference model may consume fewer resources during operation. Therefore, the data processing systems throughout the distributed system may be capable of hosting more redundant instances of the lower complexity topology inference model than the higher complexity topology inference model. Consequently, the rate of inference generation may be increased throughout the distributed system without needing to increase the quantity of available computing resources (via deploying additional data processing systems, etc.).

At operation 302, it is determined whether the inference frequency capability of the first inference model meets an inference frequency requirement of the downstream consumer during a future period of time. The determination may be made by comparing the inference frequency capability to the inference frequency requirement (e.g., a minimum threshold or other test such as a range). If the inference frequency capability exceeds the threshold (and/or is within other test requirements), then it may be determined that the inference model meets the threshold.

To make the determination, the inference frequency requirement of the downstream consumer during the future period of time may be obtained by, for example, (i) obtaining data anticipating an event impacting execution of the first inference model and (ii) obtaining the inference frequency requirement of the downstream consumer during the future period of time based on the data anticipating the event impacting execution of the first inference model.

In an embodiment, the data anticipating the event impacting execution of the first inference model is obtained by obtaining historical data indicating occurrences of events requiring a change in the inference frequency capability of the first inference model. The historical data indicating occurrences of events requiring a change in the inference frequency capability of the first inference model may be obtained via a transmission and/or via a database storing historical events and corresponding inference frequency requirements.

In an embodiment, the data anticipating an event impacting execution of the first inference model is obtained by obtaining operational data of the data processing systems (e.g., data processing systems 100). Operational data of the data processing systems may be monitored continuously and/or requested from the data processing systems as needed. Operational data may be obtained by monitoring characteristics of the data processing systems, ambient conditions surrounding the data processing systems, and/or via other methods.

In an embodiment, the data anticipating an event impacting execution of the first inference model is obtained by obtaining a transmission from the downstream consumer indicating a change in operation of the downstream consumer. The transmission from the downstream consumer indicating the change in the operation of the downstream consumer may be obtained via a communication system (e.g., communication system 101).

In an embodiment, obtaining the inference frequency requirement of the downstream consumer during the future period of time based on the data anticipating the event impacting execution of the first inference model includes feeding the data anticipating the event impacting execution of the first inference model into a second inference model. The second inference model may be a neural network inference model (or any other type of predictive model). The second inference model may be trained to predict the inference frequency requirement of the downstream consumer during the future period of time. The second inference model may be trained using training data. The training data may include a labeled dataset of data anticipating events impacting execution of the first inference model (e.g., historical data, operational data, etc.) and corresponding inference frequency requirements of the downstream consumer (or the dataset may be un-labeled). The data anticipating the event impacting the execution of the first inference model may be treated as an ingest for the second inference model and output data from the second inference model may include a prediction of the inference frequency requirement of the downstream consumer during the future period of time.

If the inference frequency capability of the first inference model meets the inference frequency requirement of the downstream consumer during the future period of time, the method may end following operation 302. If the inference frequency capability of the first inference model does not meet the inference frequency requirement of the downstream consumer during the future period of time, the method may proceed to operation 304.

At operation 304, an execution plan is obtained for the first inference model based on the inference frequency requirement of the downstream consumer during the future period of time. The execution plan may indicate instances of inference models are to be deployed, operated, etc. Refer to FIG. 3B for additional details regarding obtaining the execution plan.

At operation 306, prior to the future period of time, a deployment of the first inference model to the data processing systems is modified based on the execution plan. The deployment of the first inference model may be modified by deploying additional instances of the first inference model, deploying instances of a third inference model (refer to FIG. 3B for details regarding the third inference model) to the data processing systems, terminating existing instances of inference model, and/or otherwise modifying executing instances of inference models in accordance with the execution plan. Instructions for inference model execution and/or other instructions may also be transmitted to the data processing systems during modification of the deployment of the first inference model. These instructions may be based on the execution plan, and may cause the data processing systems that receive the instructions to conform the inference models that they host to meet the execution plan.

The method may end following operation 306.

Turning to FIG. 3B, a flow diagram illustrating a method of obtaining an execution plan is shown. The operations in FIG. 3B may be an expansion of operation 304 in FIG. 3A. The operations in FIG. 3B may be performed by inference model manager 102 and/or data processing systems 100. Other entities may perform the operations shown in FIG. 3B without departing from embodiments disclosed herein.

At operation 310, a quantity of instances of the first inference model required to meet the inference frequency requirement of the downstream consumer during the future period of time is obtained based on characteristics of the first inference model.

The quantity of instances of the first inference model required to meet the inference frequency requirement of the downstream consumer during the future period of time may be obtained by (i) obtaining the inference frequency capability of the first inference model (previously described in operation 300 in FIG. 3A), (ii) determining a quantity of instances of the first inference model currently contributing to the inference frequency capability of the first inference model, and (iii) determining whether additional instances of the first inference model should be deployed to meet the inference frequency requirement of the downstream consumer during the future period of time.

The quantity of instances of the first inference model currently contributing to the inference frequency capability may be obtained by requesting operational data of the data processing systems (e.g., data processing systems 100). The operational data of the data processing systems may include a listing of the portions of the first inference model hosted by each data processing system of the data processing systems. The portions of the first inference model hosted by each data processing system may be collected to determine the quantity of instances of the first inference model currently contributing to the inference frequency capability of the first inference model.

To determine whether additional instances of the first inference model should be deployed to meet the inference frequency requirement of the downstream consumer, the inference frequency capability of each instance of the first inference model may be identified. To do so, the inference frequency capability of the inference model may be divided by the quantity of instances of the inference model currently contributing to the inference frequency capability of the first inference model. The quantity of instances of the first inference model required to meet the inference frequency requirement of the downstream consumer during the future period of time may then be determined by dividing the inference frequency requirement by the inference frequency capability of each instance of the first inference model.

The quantity of instances of the first inference model required to meet the inference frequency requirement of the downstream consumer during the future period of time may be obtained via other methods without departing from embodiments disclosed herein.

At operation 312, it is determined whether the data processing systems have sufficient computing resource capacity to execute the quantity of instances of the first inference model. To do so, characteristics of the data processing systems and characteristics of the first inference model may be obtained, the characteristics may be used to identify available computing resources, and the available computing resource may be compared to a quantity of computing resources to host the quantity of instances of the first inference model to make the determination.

The characteristics of the data processing systems may include: (i) a quantity of the data processing systems, a quantity of available storage of each data processing system of the data processing systems, (ii) a quantity of available memory of each data processing system of the data processing systems, (iii) a quantity of available communication bandwidth between each data processing system of the data processing system and other data processing systems of the data processing systems, (iv) a quantity of available processing resources of each data processing system of the data processing systems, and/or other characteristics. The characteristics of the data processing systems may be utilized to identify a computing resource capacity of the data processing systems.

The characteristics of the first inference model may include a quantity of computing resources required to host and operate each portion of an instance of the first inference model.

The quantity of computing resources required to host and operate each portion of an instance of the first inference model and the quantity of instances of the first inference model required to meet the inference generation requirement of the downstream consumer during the future period of time may be utilized to obtain the quantity of computing resources required to host and operate the quantity of instances of the first inference model required to meet the inference generation requirement of the downstream consumer during the future period of time.

If the data processing systems have sufficient computing resource capacity to execute the quantity of instances of the first inference model, the method may proceed to operation 314. If the data processing systems do not have sufficient computing resource capacity to execute the quantity of instances of the first inference model, the method may proceed to operation 316.

At operation 314, an execution plan is obtained. The execution plan may specify which of the data processing systems are to host each of the quantity of the instances of the first inference model. The execution plan may be obtained by generating the execution plan. The execution plan may be generated by determining which portion of each instance of the first inference model should be hosted by each data processing system of the data processing systems. Generating the execution plan may also include generating instructions for execution of the first inference model including processing result destinations (e.g., which data processing system to transmit each processing result during inference generation) for each data processing system.

Returning to operation 312, the method may proceed to operation 316 if the data processing systems do not have sufficient computing resource capacity to execute the quantity of instances of the first inference model

At operation 316, a quantity of instances of the third inference model to be deployed to the data processing systems is obtained. The quantity of instances of the third inference model may be obtained by: (i) obtaining the third inference model, the third inference model being a lower complexity inference model than the first inference model and the data processing systems having capacity to host a sufficient quantity of instances of the third inference model to meet the inference frequency requirement of the downstream consumer during the future period of time; and (ii) obtaining an inference frequency capability of the third inference model while hosted by the data processing systems.

The third inference model may be obtained by training the third inference model using training data. The third inference model may also be obtained from an inference model repository storing trained inference models.

The inference frequency capability of the third inference model may be obtained by: (i) historical data (if available) indicating the rate of execution of the third inference model when hosted by the data processing systems, and/or (ii) by predicting the inference frequency capability using a fourth inference model.

The inference frequency requirement of the downstream consumer during the future period of time and the inference frequency capability of the third inference model may be utilized to determine the quantity of instances of the third inference model required to meet the inference frequency requirement of the downstream consumer during the future period of time.

At operation 318, an execution plan is obtained. The execution plan may specify which of the data processing systems are to host each of the quantity of the instances of the third inference model.

The execution plan may be obtained by generating the execution plan. The execution plan may be generated by determining which portion of each instance of the third inference model should be hosted by each data processing system (e.g., of data processing systems 100). Generating the execution plan may also include generating instructions for processing result destinations (e.g., which data processing system to transmit each processing result during inference generation) for each data processing system.

The method may end following operation 318.

Managing the execution of the inference model may be performed by inference model manager 102 and/or data processing systems 100. In a first example, the system may utilize a centralized approach to managing the execution of the inference model. In the centralized approach, an off-site entity (e.g., a data processing system hosting inference model manager 102) may make decisions and perform the operations detailed in FIGS. 3A-3B. In a second example, the system may utilize a de-centralized approach to managing the execution of the inference model. In the de-centralized approach, data processing systems 100 may collectively make decisions and perform the operations detailed in FIGS. 3A-3B. In a third example, the system may utilize a hybrid approach to managing the execution of the inference model. In the hybrid approach, and offsite entity may make high-level decisions (e.g., identifying the inference frequency requirement of the downstream consumer for the future period of time) and may delegate implementation-related decisions (e.g., obtaining the execution plan to meet the inference frequency requirement of the downstream consumer during the future period of time) to data processing systems 100. Execution of the inference model may be managed via other methods without departing from embodiments disclosed herein.

Using the method illustrated in FIGS. 3A-3B, embodiments disclosed herein may improve the reliability of distributed computations performed by data processing systems. For example, the method may facilitate modifying deployment of an inference model to meet changing inference frequency requirements of a downstream consumer.

Any of the components illustrated in FIGS. 1-2D may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method of managing execution of a first inference model hosted by data processing systems, the method comprising:
obtaining an inference frequency capability of the first inference model, the inference frequency capability indicating a rate of execution of the first inference model;
making a first determination regarding whether the inference frequency capability of the first inference model meets an inference frequency requirement of a downstream consumer during a future period of time;
in an instance of the first determination in which the inference frequency capability of the first inference model does not meet the inference frequency requirement of the downstream consumer:
obtaining an execution plan for the first inference model based on the inference frequency requirement of the downstream consumer; and
prior to the future period of time, modifying a deployment of the first inference model to the data processing systems based on the execution plan.

2. The method of claim 1, wherein the inference frequency capability of the first inference model is based on historical data indicating the rate of execution of the first inference model during a previous period of time or an analysis of the topology of the first inference model.

3. The method of claim 2, wherein making the first determination comprises:
obtaining data anticipating an event impacting execution of the first inference model; and
obtaining the inference frequency requirement of the downstream consumer during the future period of time based on the data anticipating the event impacting the execution of the first inference model.

4. The method of claim 3, wherein the data anticipating an event impacting the execution of the first inference model comprises one selected from a group consisting of:
historical data indicating occurrences of events requiring a change in the inference frequency capability of the first inference model;
current operational data of the data processing systems; and
a transmission from the downstream consumer indicating a change in operation of the downstream consumer.

5. The method of claim 4, wherein obtaining the inference frequency requirement of the downstream consumer during the future period of time comprises:
feeding the data anticipating the event impacting the execution of the first inference model into a second inference model, the second inference model being trained to predict the inference frequency requirement of the downstream consumer during the future period of time.

6. The method of claim 5, wherein the execution plan indicates a change in the deployment of the first inference model to meet the inference frequency requirement of the downstream consumer during the future period of time.

7. The method of claim 6, wherein obtaining the execution plan comprises:
obtaining a quantity of instances of the first inference model required to meet the inference frequency requirement of the downstream consumer during the future period of time based on characteristics of the first inference model;
making a second determination that the data processing systems have sufficient computing resource capacity to execute the quantity of instances of the first inference model; and
based on the second determination:
generating the execution plan specifying which of the data processing systems are to host each of the quantity of the instances of the first inference model.

8. The method of claim 6, wherein obtaining the execution plan comprises:
obtaining a quantity of instances of the first inference model required to meet the inference frequency requirement of the downstream consumer during the future period of time based on characteristics of the first inference model;
making a second determination that the data processing systems do not have sufficient computing resource capacity to execute the quantity of instances of the first inference model; and
based on the second determination:
obtaining a quantity of instances of a third inference model to be deployed to the data processing systems based on the inference frequency requirement of the downstream consumer during the future period of time; and
generating the execution plan specifying which of the data processing systems are to host each of the quantity of the instances of the third inference model.

9. The method of claim 8, wherein obtaining the quantity of the instances of the third inference model comprises:
obtaining the third inference model, the third inference model being a lower complexity inference model than the first inference model and the data processing systems having capacity to host a sufficient quantity of instances of the third inference model to meet the inference frequency requirement of the downstream consumer during the future period of time; and
obtaining an inference frequency capability of the third inference model while hosted by the data processing systems.

10. A non-transitory machine-readable medium having instructions stored therein, which when executed by a processor, cause the processor to perform operations for managing execution of a first inference model hosted by data processing systems, the operations comprising:
obtaining an inference frequency capability of the first inference model, the inference frequency capability indicating a rate of execution of the first inference model;
making a first determination regarding whether the inference frequency capability of the first inference model meets an inference frequency requirement of a downstream consumer during a future period of time;
in an instance of the first determination in which the inference frequency capability of the first inference model does not meet the inference frequency requirement of the downstream consumer:
obtaining an execution plan for the first inference model based on the inference frequency requirement of the downstream consumer; and
prior to the future period of time, modifying a deployment of the first inference model to the data processing systems based on the execution plan.

11. The non-transitory machine-readable medium of claim 10, wherein the inference frequency capability of the first inference model is based on historical data indicating the rate of execution of the first inference model during a previous period of time.

12. The non-transitory machine-readable medium of claim 11, wherein making the first determination comprises:
obtaining data anticipating an event impacting execution of the first inference model; and
obtaining the inference frequency requirement of the downstream consumer during the future period of time based on the data anticipating the event impacting the execution of the first inference model.

13. The non-transitory machine-readable medium of claim 12, wherein the data anticipating an event impacting the execution of the first inference model comprises one selected from a group consisting of:
historical data indicating occurrences of events requiring a change in the inference frequency capability of the first inference model;
current operational data of the data processing systems; and
a transmission from the downstream consumer indicating a change in operation of the downstream consumer.

14. The non-transitory machine-readable medium of claim 13, wherein obtaining the inference frequency requirement of the downstream consumer during the future period of time comprises:
feeding the data anticipating the event impacting the execution of the first inference model into a second inference model, the second inference model being trained to predict the inference frequency requirement of the downstream consumer during the future period of time.

15. The non-transitory machine-readable medium of claim 14, wherein the execution plan indicates a change in the deployment of the first inference model to meet the inference frequency requirement of the downstream consumer during the future period of time.

16. A data processing system, comprising:
a processor; and
a memory coupled to the processor to store instructions, which when executed by the processor, cause the processor to perform operations for managing execution of a first inference model hosted by data processing systems, the operations comprising:
obtaining an inference frequency capability of the first inference model, the inference frequency capability indicating a rate of execution of the first inference model;
making a first determination regarding whether the inference frequency capability of the first inference model meets an inference frequency requirement of a downstream consumer during a future period of time;
in an instance of the first determination in which the inference frequency capability of the first inference model does not meet the inference frequency requirement of the downstream consumer:
obtaining an execution plan for the first inference model based on the inference frequency requirement of the downstream consumer; and
prior to the future period of time, modifying a deployment of the first inference model to the data processing systems based on the execution plan.

17. The data processing system of claim 16, wherein the inference frequency capability of the first inference model is based on historical data indicating the rate of execution of the first inference model during a previous period of time.

18. The data processing system of claim 17, wherein making the first determination comprises:
obtaining data anticipating an event impacting execution of the first inference model; and
obtaining the inference frequency requirement of the downstream consumer during the future period of time based on the data anticipating the event impacting the execution of the first inference model.

19. The data processing system of claim 18, wherein the data anticipating an event impacting the execution of the first inference model comprises one selected from a group consisting of:
historical data indicating occurrences of events requiring a change in the inference frequency capability of the first inference model;
current operational data of the data processing systems; and
a transmission from the downstream consumer indicating a change in operation of the downstream consumer.

20. The data processing system of claim 19, wherein obtaining the inference frequency requirement of the downstream consumer during the future period of time comprises:
feeding the data anticipating the event impacting the execution of the first inference model into a second inference model, the second inference model being trained to predict the inference frequency requirement of the downstream consumer during the future period of time.
